(19) United States
(12) Patent Application Publication
(10) Pub. No.: US 2011/0119237 A1
(43) Pub. Date: May 19, 2011

(54) ADAPTATION DATA FILE PROVIDING APPARATUS, ADAPTATION DATA FILE PROCESSING APPARATUS, AND AIR TRAFFIC CONTROL SYSTEM AND METHOD

(75) Inventors: Do-Woo KIM, Daejeon (KR); Jong-Wook Han, Daejeon (KR); Hyo-Dal Park, Daejeon (KR); Seung-Hee Oh, Daejeon (KR); Seoung hyeon Lee, Daejeon (KR); Deok Gyu Lee, Daejeon (KR)

(73) Assignees: Electronics and Telecommunications Research Institute, Daejeon (KR); INHA Industry Partnership Institute, Incheon (KR)

(21) Appl. No.: 12/763,361

(22) Filed: Apr. 20, 2010

(30) Foreign Application Priority Data
Nov. 16, 2009 (KR) 10-2009-0110303

(51) Int. Cl. G06F 17/30

(52) U.S. Cl. 707/687; 707/E17.005; 707/E17.01

(57) ABSTRACT

An adaptation data file providing apparatus is operated by at least one subsystem among subsystems configuring an air traffic control system that provides an air traffic control service. The apparatus includes: a data input unit for receiving adaptation data required to provide the air traffic control service; and a file generation unit for generating an adaptation file, which has a form to be transmittable to subsystems and is obtained by generating metadata for being used to check errors in the adaptation data and including the metadata and the adaptation data input through the data input unit therein.

### CROSS-REFERENCE(S) TO RELATED APPLICATION

The present invention claims priority of Korean Patent Application No. 10-2009-0110303, filed on Nov. 16, 2009, which is incorporated herein by reference.

### FIELD OF THE INVENTION

The present invention relates to an adaptation data file providing apparatus, an adaptation data file processing apparatus, and an air traffic control system and method, and more particularly, to an adaptation data file providing apparatus and an adaptation data file processing apparatus, in which a transmitting subsystem generates metadata for checking errors when creating or changing adaptation data and transmits an adaptation data file and a receiving subsystem checks errors by using metadata transmitted from other subsystems without using a value prestored in the receiving side when checking the adaptation data of the adaptation data file, and an air traffic control system and method.

### BACKGROUND OF THE INVENTION

As well-known in the art, an air traffic control system provides an air traffic control service to promote the safe, orderly, and expeditious flow of air traffic. Safety is principally a matter of preventing collisions with other aircraft, obstructions, and the ground; assisting aircraft in avoiding hazardous weather; assuring that aircraft does not operate in airspace where operations are prohibited; and assisting aircraft in distress. Orderly and expeditious air traffic flow assures the efficiency of aircraft operations along selected routes. It is provided through the equitable allocation of airspaces (or resources) to individual flights, generally on a first-come-first-served basis. Such air traffic control system employs a type of computer and display system that processes data received from radar systems for the detection and tracking of aircraft. This system is used for both civilian and military applications to determine the identity and location of aircraft in a particular geographic area.

Meanwhile, the air traffic control system utilizes adaptation data required for system operation.

As a way to utilize adaptation data in a conventional air traffic control system, one of various subsystems configuring the air traffic control system generates or changes adaptation data required for system operation and then serves as a transmitting side to transmit the adaptation data to other subsystems. Further, receiving subsystem receiving the adaptation data performs parsing of the adaptation data analyzes and interprets an error check value prestored in the receiving subsystem, checks errors by using the error check value obtained by analyzing a parsing tree generated after the parsing, and processes the checked adaptation data in a specific form and stores and uses it.

However, in the conventional air traffic control system, errors in the adaptation data are checked by using the error check value prestored in the receiving subsystem, and therefore the error check value has to be analyzed and interpreted before checking. It takes time for the analysis and interpretation to be done, and if an error occurs in the analysis and interpretation process, this directly causes a check error of the adaptation data and thus the accuracy of error check of the adaptation data is low. Accordingly, it was difficult to improve the performance of the subsystems, which acts as a limiting factor in efficiently utilizing the adaptation data.

### SUMMARY OF THE INVENTION

Therefore, the present invention provides an adaptation data file providing apparatus and an adaptation data file processing apparatus, in which a transmitting subsystem generates metadata for checking errors when creating or changing adaptation data and transmits an adaptation data file and a receiving subsystem checks errors by using the metadata transmitted from other subsystems without using a, value prestored in the receiving side when checking the adaptation data of the adaptation data file, an air traffic control system and method.

The present invention further provides an adaptation data file processing apparatus and an air traffic control system and method, which are adapted to transform the adaptation data checked for errors in the form of a preprocessed file in a programming language.

In accordance with a first aspect of the present invention, there is provided an adaptation data file providing apparatus operated by at least one subsystem among subsystems configuring an air traffic control system that provides an air traffic control service. The apparatus includes: a data input unit for receiving adaptation data required to provide the air traffic control service; and a file generation unit for generating an adaptation file, which has a form to be transmittable to subsystems and is obtained by generating metadata for being used to check errors in the adaptation data and including the metadata and the adaptation data input through the data input unit therein.

In accordance with a second aspect of the present invention, there is provided an adaptation data file providing method, which is performed by at least one subsystem among subsystems configuring an air traffic control system that provides an air traffic control service.

The method includes: receiving adaptation data required to provide the air traffic control service; and generating an adaptation file, which has a form to be transmittable to subsystems and is obtained by generating metadata for being used to check errors in the adaptation data and including the metadata and the adaptation data input therein.

In accordance with a third aspect of the present invention, there is provided an adaptation data file processing apparatus, which is operated by one subsystem among subsystems configuring an air traffic control system that provides an air traffic control service.

The apparatus includes a data parsing unit for receiving an adaptation data file that has metadata and an adaptation data, parsing the adaptation data file to extract the adaptation data, and checking errors in the adaptation data by using the metadata; and a preprocessed file generation unit for transforming the adaptation data checked for errors by the data parsing unit into the form of a preprocessed file in a programming language used to implement the subsystems.

In accordance with a fourth aspect of the present invention, there is provided an adaptation data file processing method, which is performed by one subsystem among subsystems configuring an air traffic control system that provides an air traffic control service.

The method includes: receiving an adaptation data file that has metadata and adaptation data; checking errors in the adaptation data by using the metadata by parsing the adaptation data file to extract the adaptation data; and transforming the adaptation data checked for errors by said checking errors into the form of a preprocessed file in a programming language used to implement the subsystems.

In accordance with a fifth aspect of the present invention, there is provided an air traffic control system for providing an air traffic control service.

The system includes a plurality of subsystems, wherein one of the subsystems receives adaptation data required to provide the air traffic control service, generates an adaptation file, which has a form to be transmittable to other subsystems and is obtained by generating metadata for being used to check errors in the adaptation data and including the metadata and the adaptation data input therein, and transmits the adaptation data file to other subsystem of the subsystems, and the other system receives the adaptation data file, parses the adaptation data file to extract the adaptation data, checks errors in the adaptation data by using the metadata, and transforms the adaptation data checked for errors into a form of a preprocessed file in a programming language used to implement the subsystems.

In accordance with a sixth aspect of the present invention, there is provided an air traffic control method executed by an air traffic control system including a plurality of subsystems. The method includes: at least one of the subsystems, receiving adaptation data required to provide the air traffic control service, generating an adaptation file, which has a form to be transmittable to other subsystems and is obtained by generating metadata for being used to check errors in the adaptation data and including the metadata and the adaptation data input therein, and transmitting the adaptation data file to other subsystem of the subsystems; and at the other system, receiving the adaptation data file, parsing the adaptation data file to extract the adaptation data, checking errors in the adaptation data by using the metadata, and transforming the adaptation data checked for errors into a form of a preprocessed file in a programming language used to implement the subsystems.

### BRIEF DESCRIPTION OF THE DRAWINGS

The above and other objects and features of the present invention will become apparent from the following description of. embodiments, given in conjunction with the accompanying drawings, in which:

FIG. 1 is a network configuration view showing an application example of an air traffic control system in accordance with an embodiment of the present invention;

FIG. 2 illustrates a block diagram showing the configuration of an adaptation data file providing apparatus and the configuration of an adaptation data file processing apparatus in accordance with an embodiment of the present invention; and

FIG. 3 illustrates a flowchart for explaining an adaptation data file providing method and an adaptation data file processing method in accordance with an embodiment of the present invention.

### DETAILED DESCRIPTION OF THE EMBODIMENTS

Hereinafter, embodiments of the present invention will be described in detail with reference to the accompanying drawings which form a part hereof.

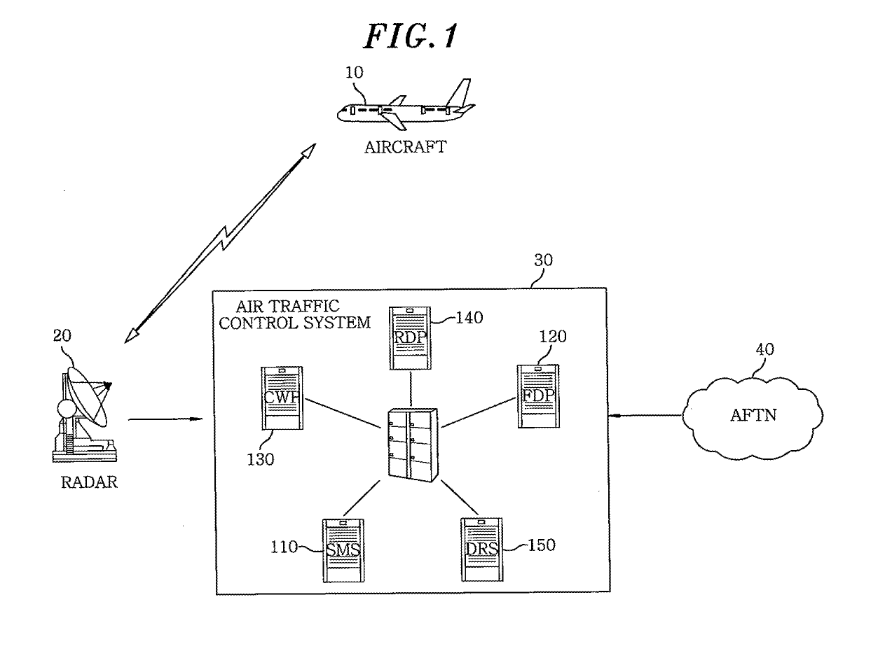

FIG. 1 is a network configuration view showing an application example of an air traffic control system in accordance with an embodiment of the present invention.

The inventive air traffic control system 30 shown in FIG. 1 provides an air traffic control service to promote the safe, orderly, and expeditious flow of air traffic by communicating with an aircraft 10 through a radar 20, and configures a network along with an aeronautical fixed telecommunication network (AFTN) 40.

Such an air traffic control system 30 includes a plurality of subsystems, and examples thereof include a software maintenance system (SMS) 110, a flight data processing (FDP) system 120, a control working position (CWP) system 130, a radar data processing system (RDP) 140, and a data recording system (DRS) 150.

The SMS 110 provides an air traffic control service to promote the safe flow of air traffic by communicating with the aircraft 10 through the radar 20 and working in conjunction with the FDP system 120, the CWP system 130, and the RDP 140.

The FDP system 120 processes flight plan data of airlines or the like input via the AFTN 40 and delivers it to the SMS 110, the CWP system 130, and the RDP 140.

The RDP 140 processes data input from the radar 20 and delivers it to the CWP system 130.

The CWP system 130 serves to perform surveillance and control of airfield lighting and surface movement guidance function, and to identify the aircraft 10 based on information from the FDP system 120 and information from the RDP 140.

The DRS 150 backs up and stores contents of all information input into the air traffic control system 30, and uses them as data for investigation in an event of an accident.

At least one of these subsystems becomes an adaptation data file providing apparatus in accordance with an embodiment of the present invention, which generates or changes adaptation data required for system operation and then serves as a transmitting side to transmit the adaptation data to other subsystems, and the other subsystems becomes an adaptation data file processing apparatus in accordance with an embodiment of the present invention, which performs parsing of the adaptation data, checks errors in a parsing tree generated after the parsing, and processes the checked adaptation data in a specific form and stores and uses it.

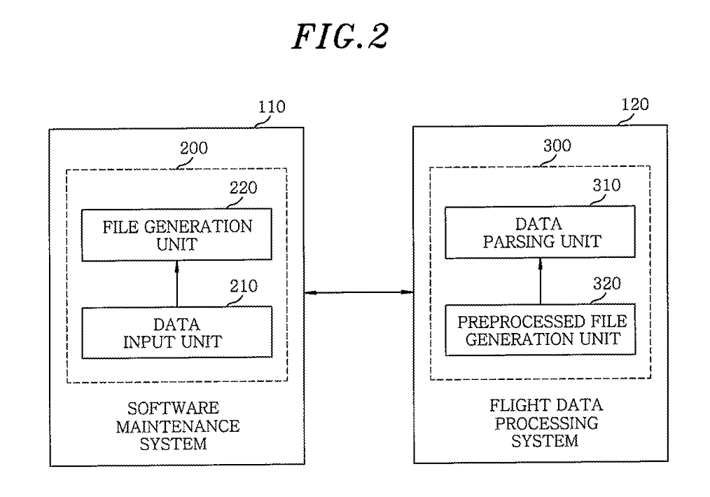

FIG. 2 illustrates a block diagram showing the configuration of the adaptation data file providing apparatus and the configuration of the adaptation data file processing apparatus in accordance with an embodiment of the present invention. One or a plurality of subsystems among the subsystems configuring the air traffic control system may operate the adaptation data file providing apparatus 200 in accordance with an embodiment of the present invention, and another one among the remaining subsystems may operate the adaptation data file processing apparatus 300. FIG. 2 shows an example in which, among the subsystems, the SMS 110 operates the adaptation data file providing apparatus 200, and the FDP system 120 operates the adaptation data file processing apparatus 300.

As shown therein, the adaptation data file providing apparatus 200 includes a data input unit 210 and a file generation unit 220.

The data input unit 210 receives adaptation data required to provide an air traffic control service.

The file generation unit 220 generates metadata which is used to check errors in the adaptation data. Then, the file generation unit 220 generates an adaptation file which has a form to be transmittable to other subsystems by including the metadata and the adaptation data input through the data input unit 210.

The adaptation data file processing apparatus 300 includes a data parsing unit 310 and a preprocessed file generation unit 320.

The data parsing unit 310 receives the adaptation data file that includes metadata with the adaptation file having adaptation data, parses the adaptation data file to extract the adaptation data, and checks errors in the adaptation data using the metadata.

The preprocessed file generation unit 320 transforms the adaptation data checked for errors by the data parsing unit 310 into the form of a preprocessed file in a programming language used to implement the subsystems.

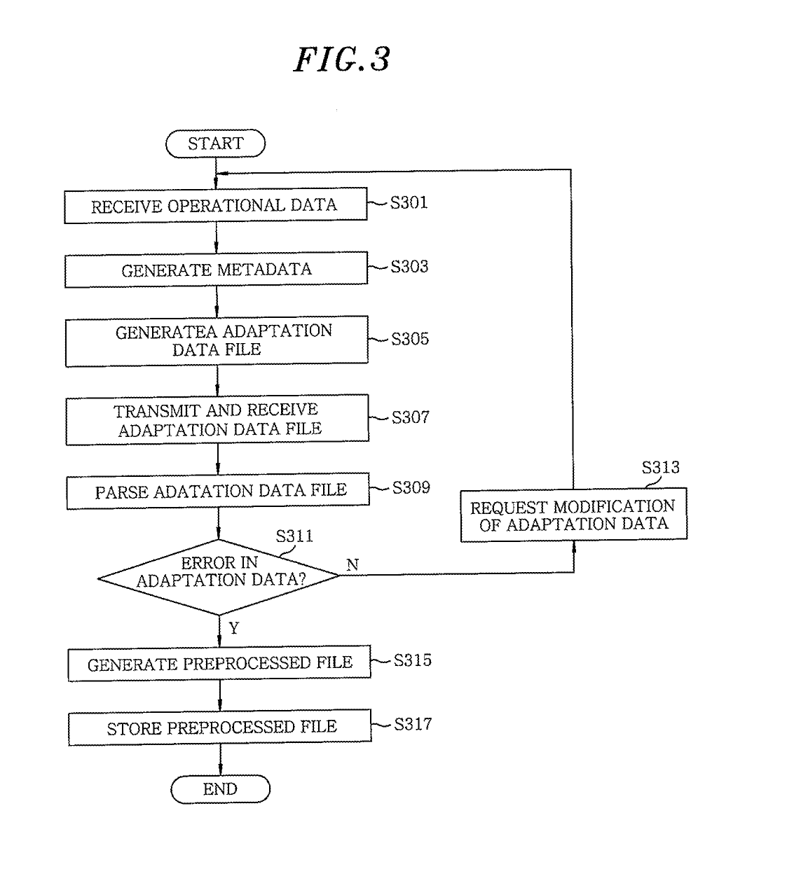

FIG. 3 illustrates a flowchart for explaining an adaptation data file providing method and an adaptation data file processing method in accordance with an embodiment of the present invention.

Hereinafter, a method of processing adaptation data in the air traffic control system in accordance with an embodiment of the present invention will be described with reference to FIGS. 1 to 3. Here, a description will be given on an example in which the SMS 110 operates the adaptation data file providing apparatus 200 and the FDP system 120 operates the adaptation data file processing apparatus 300.

First, at step S301, the data input unit 210 in the adaptation data file providing apparatus 200 operated by the SMS 110 receives adaptation data required to provide an air traffic control service, i.e., operational data required for the processing of control data. The adaptation data is data required for the operation of each of the subsystems in order to provide an air traffic control service, and includes such information as the type, features, maximum speed, maximum altitude, minimum rotation angle and the like of the aircraft 10. To this end, the data input unit 210 may be implemented in a Graphical User Interface (GUI).

Then, the file generation unit 220 in the adaptation data file providing apparatus 200 operated by the SMS 110 generates metadata which is used to check errors in the adaptation data at step S303.

Then, the file generation unit 220 generates an adaptation file which has a form to be transmittable to other subsystems by including the metadata and the adaptation data input through the data input unit 210 at step S305.

Here, the adaptation file may be a data formats including extensible markup language (XML), hypertext markup language (HTML), and a text (TXT) format. Here, the metadata may be generated to be used for checking errors in the entire adaptation data or generated to be used for checking errors in some important data, so that an error checking process to be done later can be quickly performed. For instance, a description of the corresponding information may be included to check errors in the data directly associated with safety, such as the maximum speed, maximum altitude, minimum rotation angle or the like among the adaptation data including such information as the type, features, maximum speed, maximum altitude, minimum rotation angle and the like of the aircraft 10.

Once the adaptation data file is generated as above, at step S307, the file generation unit 220 transmits the adaptation data file including the adaptation data to other subsystem, i.e., FDP system 120, and the data parsing unit 310 in the adaptation data file processing apparatus 300 operated by the FDP system 120 receives the adaptation data file.

Next, the data parsing unit 310 in the adaptation data file processing apparatus 300 parses the adaptation data file to extract the adaptation data at step S309, and checks errors in the adaptation data by using the metadata, that is, checks the accuracy of the adaptation data at step S311. For instance, some important data (e.g., maximum speed, maximum altitude, minimum rotation angle, etc.) directly associated with safety, among the information included in the adaptation data, is compared with the metadata to check the accuracy of the adaptation data.

If it is checked that there has occurred an error in the adaptation data, the data parsing unit 310 sends a request to the subsystem, i.e., SMS 110, that sent the adaptation data among the subsystems to modify the adaptation data at step 5313 to re-receives the adaptation data.

On the other hand, if it is checked that there has occurred no error in the adaptation data, the data parsing unit 310 in the adaptation data file processing apparatus 300 provides a syntax tree generated through the parsing at step S309 to the preprocessed file generation unit 320 in the adaptation data file processing apparatus 300.

Next, at step 5315, the preprocessed file generation unit 320 in the adaptation data file processing apparatus 300 transforms the adaptation data into the form of a preprocessed file in a programming language used to implement the subsystems by using the syntax tree provided from the data parsing unit 310. For example, programming languages, such as C, Java, Ada and the like may be used to implement the subsystems.

Thereafter, at step S317, the preprocessed file generation unit 320 in the adaptation data file processing apparatus 300 stores the adaptation data transformed into the form of the preprocessed file, wherein the stored adaptation data in the form of the preprocessed file is preprocessed before the compiling process of a subsystem and used to execute the corresponding subsystem.

Although the embodiments in accordance with the present invention have been described with respect to an example in which one of the subsystems configuring the air traffic control system 30 operates the data input unit 210 and the file generation unit 220 of the adaptation data file providing apparatus 200, other subsystem among the subsystems configuring the air traffic control system 30 may additionally operate the file generation unit 220 in the adaptation data file providing apparatus 200. At this time, the file generation unit 220 that is additionally operated may not itself generate metadata of an adaptation data file, but changes the metadata included in the adaptation data file generated and provided by other subsystems and provides the adaptation data file including the changed metadata to the adaptation data file processing apparatus 300.

In accordance with the present invention, a transmitting subsystem generates metadata for checking errors when creating adaptation data and transmits an adaptation data file and a receiving subsystem checks errors by using the metadata transmitted from the transmitting subsystem without using a value prestored in the receiving side when checking the adaptation data of the adaptation data file, thereby improving the performance of subsystems by increasing the accuracy of error check.

In addition, the present invention transforms the adaptation data checked for errors into the form of a preprocessed file in a programming language, thereby enhancing management efficiency of the adaptation data within the subsystems.

While the invention has been shown and described with respect to the particular embodiments, it will be understood by those skilled in the art that various changes and modification may be without departing from the scope of the invention as defined in the following claims.

What is claimed is:

1. An adaptation data file providing apparatus, which is operated by at least one subsystem among subsystems configuring an air traffic control system that provides an air traffic control service, the apparatus comprising:
a data input unit for receiving adaptation data required to provide the air traffic control service; and
a file generation unit for generating an adaptation file, which has a form to be transmittable to subsystems and is obtained by generating metadata for being used to check errors in the adaptation data and including the metadata and the adaptation data input through the data input unit therein.

2. The apparatus of claim 1, wherein the data input unit and the file generation unit are operated by one of the subsystems.

3. The apparatus of claim 2, wherein another one of the subsystems operates the file generation unit.

4. The apparatus of claim 1, wherein the adaptation file is generated in one of extensible markup language (XML), hypertext markup language (HTML), and text formats.

5. The apparatus of claim 1, wherein the metadata is used for checking errors in parts of the entire adaptation data.

6. An adaptation data file providing method, which is performed by at least one subsystem among subsystems configuring an air traffic control system that provides an air traffic control service, the method comprising:
receiving adaptation data required to provide the air traffic control service; and
generating an adaptation file , which has a form to be transmittable to subsystems and is obtained by generating metadata for being used to check errors in the adaptation data and including the metadata and the adaptation data input therein.

7. The method of claim 6, wherein said receiving adaptation data and said generating an adaptation file are performed by one of the subsystems.

8. The method of claim 7, wherein another one of the subsystems operates performs said generating an adaptation file.

9. The method of claim 6, wherein the adaptation file is generated in one of extensible markup language (XML), hypertext markup language (HTML), and text formats.

10. The method of claim 6, wherein the metadata is used for checking errors in parts of the entire adaptation data.

11. An adaptation data file processing apparatus, which is operated by one subsystem among subsystems configuring an air traffic control system that provides an air traffic control service, the apparatus comprising:
a data parsing unit for receiving an adaptation data file that has metadata and an adaptation data, parsing the adaptation data file to extract the adaptation data, and checking errors in the adaptation data by using the metadata; and
a preprocessed file generation unit for transforming the adaptation data checked for errors by the data parsing unit into the form of a preprocessed file in a programming language used to implement the subsystems.

12. The apparatus of claim 11, wherein the data parsing unit checks errors in parts of the entire adaptation data by using the metadata.

13. The apparatus of claim 11, wherein, if there has occurred an error in the adaptation data, the data parsing unit sends a request to the subsystem that sent the adaptation data among the subsystems to modify the adaptation data.

14. The apparatus of claim 11, wherein, if there has occurred no error in the adaptation data, the data parsing unit provides a syntax tree generated through the parsing to the preprocessed file generation unit, and the preprocessed file generation unit generates the preprocessed file using the syntax tree.

15. An adaptation data file processing method, which is performed by one subsystem among subsystems configuring an air traffic control system that provides an air traffic control service, the method comprising:
receiving an adaptation data file that has metadata and adaptation data;
checking errors in the adaptation data by using the metadata by parsing the adaptation data file to extract the adaptation data; and
transforming the adaptation data checked for errors by said checking errors into the form of a preprocessed file in a programming language used to implement the subsystems.

16. The method of claim 15, wherein said checking errors in the adaptation data checks errors in parts of the entire adaptation data using the metadata.

17. The method of claim 15, further comprising, if it is checked in said checking errors that there has occurred an error in the adaptation data, sending a request to the subsystem that sent the adaptation data among the subsystems to modify the adaptation data.

18. The method of claim 15, wherein, if there has occurred no error in the adaptation data, and said transforming the adaptation data generates the preprocessed file using the syntax tree generated through said parsing.

19. An air traffic control system for providing an air traffic control service, comprising:
a plurality of subsystems,
wherein one of the subsystems receives adaptation data required to provide the air traffic control service, generates an adaptation file, which has a form to be transmittable to other subsystems and is obtained by generating metadata for being used to check errors in the adaptation data and including the metadata and the adaptation data input therein, and transmits the adaptation data file to other subsystem of the subsystems, and
the other system receives the adaptation data file, parses the adaptation data file to extract the adaptation data, checks errors in the adaptation data by using the metadata, and transforms the adaptation data checked for errors into a form of a preprocessed file in a programming language used to implement the subsystems.

20. An air traffic control method executed by an air traffic control system including a plurality of subsystems, comprising:
at least one of the subsystems, receiving adaptation data required to provide the air traffic control service, generating an adaptation file, which has a form to be transmittable to other subsystems and is obtained by generating metadata for being used to check errors in the adaptation data and including the metadata and the adaptation data input therein, and transmitting the adaptation data file to other subsystem of the subsystems; and
at the other system, receiving the adaptation data file, parsing the adaptation data file to extract the adaptation data, checking errors in the adaptation data by using the metadata, and transforming the adaptation data checked for errors into a form of a preprocessed file in a programming language used to implement the subsystems.
